(19) United States
(12) Patent Application Publication
(10) Pub. No.: US 2013/0145693 A1
(43) Pub. Date: Jun. 13, 2013

(54) Self-Illuminating Fire Door

(71) Applicant: Shaobin LI, Shenzhen (CN)

(72) Inventor: Shaobin LI, Shenzhen (CN)

(73) Assignee: Shenzhen Guangan Fire-Fighting & Decoration Engineering Co., LTD, Shenzhen (CN)

(21) Appl. No.: 13/323,789

(22) Filed: Dec. 12, 2011

(51) Int. Cl. E06B 5/16; G09F 13/20

(52) U.S. Cl. 49/70; 40/542

(57) ABSTRACT

A self-illuminating fire door includes a door body (10) and a door frame (20), each having a front and a rear sides respectively, includes a self-illuminating member (30) on at least one side of the door body (10) and the door frame (20). The self-illuminating member (30) is made in self-illuminating material and constructed into a block unit, a rod unit or a flat film body unit. The block unit or the rod unit is mounted onto the door body (10) or the door frame (20) at one or both sides. The flat film unit is stick or bonded onto the door body (10) or the door frame (20) at one or both sides. The self-illuminating material is alkaline earth alluminate material, a light-storing type self-illuminating material. The fire door can illuminate under a dark condition or at night, thereby guiding people to exit route to escape from the fire.

### BACKGROUND OF THE PRESENT INVENTION

1. Field of Invention

The present invention relates to fire door in fire control, and more particularly to a fire door which is capable of self-illuminating under dark environmental condition or at night.

2. Description of Related Arts

Nowadays, the pace of industrial development and urbanization become faster and faster. The large cities in the world are loaded with high rise buildings and high population density, and therefore much weight is put onto the cities. The dramatic increase in population and the fast-paced industrial development have led to a great increase in electric usage. In addition, problems of aging electrical appliances, ineffective safety and precaution measures, human damage, terror attack and etc. have posed a hidden threat to fire accidents which may be easily occurred in high rise buildings in the cities. Fire occurred in high rise buildings will cause direct threat to residents or tenants in higher levels. In order to ensure fire safety, many buildings have fire doors being installed such that when a fire is occurred, the fire door can block the fire outside the fire door to enter inside, or can prevent the fire being spread to outside, while guiding people to enter the exit route or fire escape path through the fire door. However, conventional fire door fails to provide obvious and prominent guiding mark, especially when the fire is occurred at night, and people cannot see clearly and locate the fire door, and may therefore miss the best timing for escape.

### SUMMARY OF THE PRESENT INVENTION

An object of the present invention is to solve the above problem and provide a self-illuminating fire door which is capable of illuminating under dark environmental condition or a night-time condition in which no visible light is available, thereby capable of guiding people to exit route to escape from the fire when a fire is occurred.

Additional advantages and features of the invention will become apparent from the description which follows, and may be realized by means of the instrumentalities and combinations particular point out in the appended claims.

According to the present invention, the foregoing and other objects and advantages are attained by a self-illuminating fire door, comprising a door body and a door frame pivotally mounted together, wherein the door body has two sides defining a front side and a rear side and providing a front surface and a rear surface respectively, the door frame has two sides defining a front side and a rear side and providing a front surface and a rear surface respectively, wherein the fire door comprises one or more self-illuminating members provided on one or more sides of the door body and the door frame.

The self-illuminating member is made in self-illuminating material which is capable of providing illumination in the dark and is constructed into a block unit, a rod unit or a flat film body unit.

The self-illuminating member is in a form of the block unit or the rod unit and is mounted onto the door body at the front surface of the front side of the door body or the rear surface of the rear side of the door body, or onto the door frame at the front surface of the front side of the door frame or the rear surface of the rear side of the door frame, or two self-illuminating members are provided on the front and the rear side of the door body or of the door body respectively.

The self-illuminating member is in a form of the block unit or the rod unit and is mounted onto the front surface of the front side of the door body, the rear surface of the rear side of the door body, the front surface of the front side of the door frame or the rear surface of the rear side of the door frame at a center or peripheral position.

The self-illuminating member is in a form of the film body unit and is stick or bonded onto the door body at the front surface of the front side of the door body or the rear surface of the rear side of the door body, or onto the door frame at the front surface of the front side of the door frame or the rear surface of the rear side of the door frame.

The self-illuminating member is made in self-illuminating material and is constructed into a text or a graphical form.

The self-illuminating member is in a form of the film body unit which is made in self-illuminating material and is constructed into a text or a graphical form. In other words, the self-illuminating member is in the text form or in the graphical form which can be bonded or stick onto the front surface of the front side of the door body, the rear surface of the rear side of the door body, the front surface of the front side of the door frame or the rear surface of the rear side of the door frame.

The self-illuminating member is provided at a center or peripheral position of the front surface of the front side of the door body, the rear surface of the rear side of the door body, the front surface of the front side of the door frame or the rear surface of the rear side of the door frame.

The self-illuminating material is an alkaline earth alluminate material, which is a light-storing type self-illuminating material.

The self-illuminating material has a material form selected from the group consisting of powder form, film form, block form and rod form.

The essence of the present invention is to provide a fire control method which is simple but effective. Since the self-illuminating member is provided on the fire door, the fire door can therefore provide illumination without electricity in a dark environment such as during night-time or when light is not available, thereby the illumination of the fire door can serve as a sign to providing a guiding effect. When there is a fire, people can first hide on one side of the fire door which is at an opposite of the fire, and then escape from the fire scene through the exit route. Because the fire door can inherently block the spread of the fire, and the illuminating effect provided by the fire door can provide guidance, therefore the self-illuminating fire door can provide a guiding effect in assisting escape and saved the valuable time during escape. The fire door of the present invention is advantageous in providing features of simple construction, easy implementation and promotion, and etc.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an illustration of a fire door according to an exemplary embodiment 1 of a preferred embodiment of the present invention.

FIG. 2 is an illustration of a fire door according to an exemplary embodiment 2 according to the above preferred embodiment of the present invention, wherein FIG. 2A is an illustration of a front side of a door body, and FIG. 2B is an illustration of a rear side of a door body.

FIG. 3 is an illustration of a fire door according to an exemplary embodiment 3 according to the above preferred embodiment of the present invention, wherein FIG. 3A is an illustration of a front side of a door frame, and FIG. 3B is an illustration of a rear side of a door frame.

FIG. 4 is an illustration of a fire door according to an exemplary embodiment 4 according to the above preferred embodiment of the present invention, wherein FIG. 4A is an illustration of a front side of a door frame and a door body, and FIG. 4A is an illustration of a rear side of a door frame and a door body,

### DETAILED DESCRIPTION OF THE PREFERRED EMBODIMENT

The present invention is further described through the following exemplary embodiments and the accompanying drawings, and not intended to be limiting.

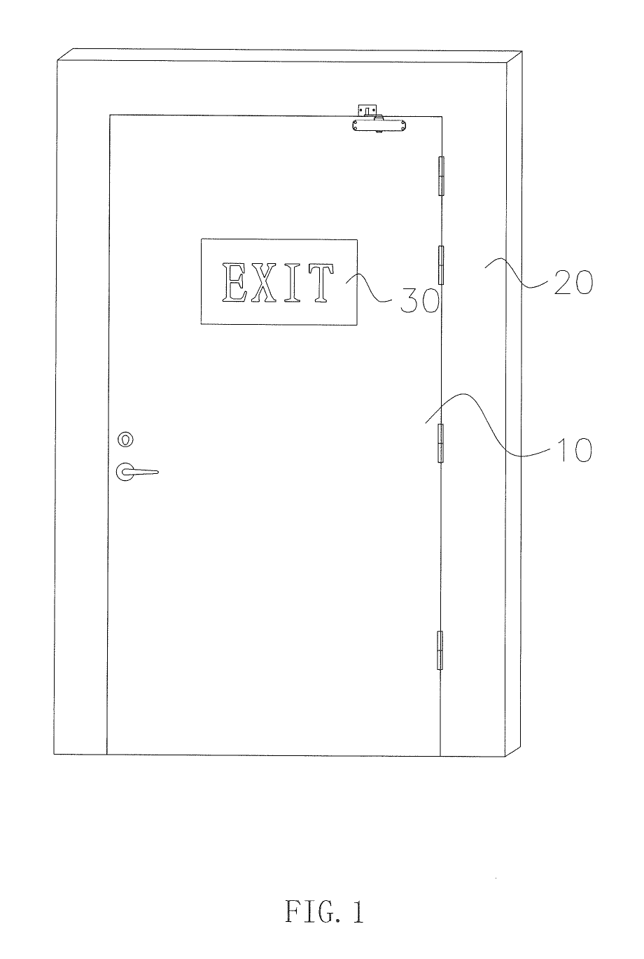

Referring to FIGS. 1 to 3 of the drawings, a self-illuminating fire door according to a preferred embodiment of the present invention includes a door frame 20; a door body 10 installed onto the door frame 20 for forming the fire door of which the door body 10 has a front side and a rear side defining a front surface and a rear surface respectively; and a self-illuminating member 30 provided on the front surface of the front side, the rear surface of the rear side, or at least one side of the front and the rear sides of the door body 10.

### Exemplary Embodiment 1

Referring to FIG. 1 of the drawings, the front surface of the front side of the door body 10 further defines a center portion at which the self-illuminating member 30 is positioned. The self-illuminating member 30 is made in self-illuminating material which is capable of providing illumination under a dark condition. The self-illuminating member 30 can be constructed into a block unit, a rod unit or a flat film body unit. In this embodiment, the self-illuminating member 30 is constructed into a block unit which can be designed to form a safety sign in a graphical form or in a text form, such as “ [symbol] [symbol] ” in Chinese, “EXIT” in English or “ [symbol] ” in graphical form. The safety sign is a block unit and is mounted firmly onto the center portion of the front surface of the front side of the door body 10. The self-illuminating member 30 is made of alkaline earth alluminate material to form a light-storing type self-illuminating block unit which is capable of absorbing and storing light energy from natural light or artificial lighting (such as electric light) and emitting light under the dark condition or at night, therefore the self-illuminating member 30 is capable of providing a guiding light effect.

### Exemplary Embodiment 2

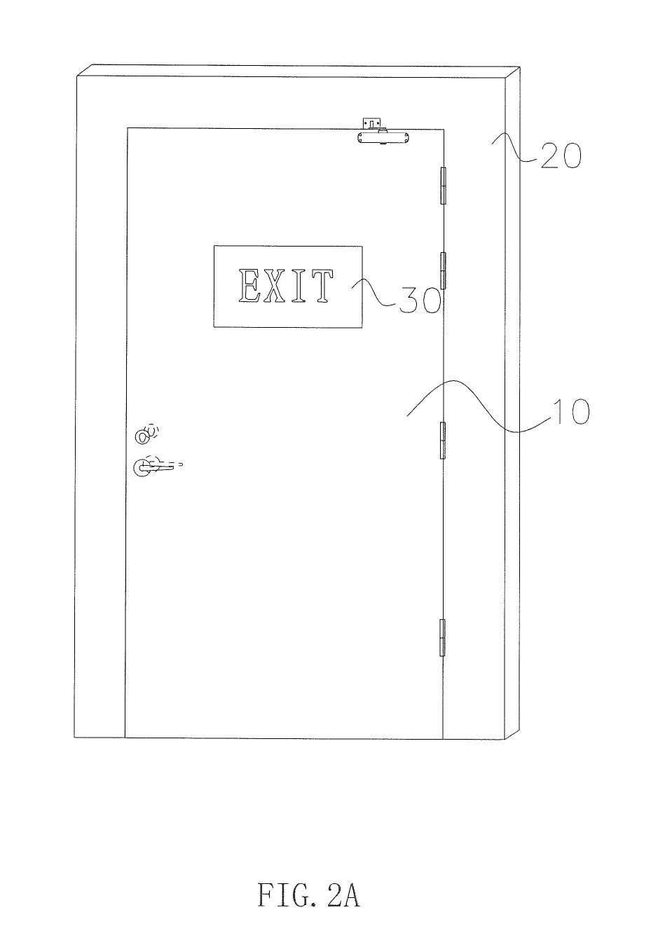

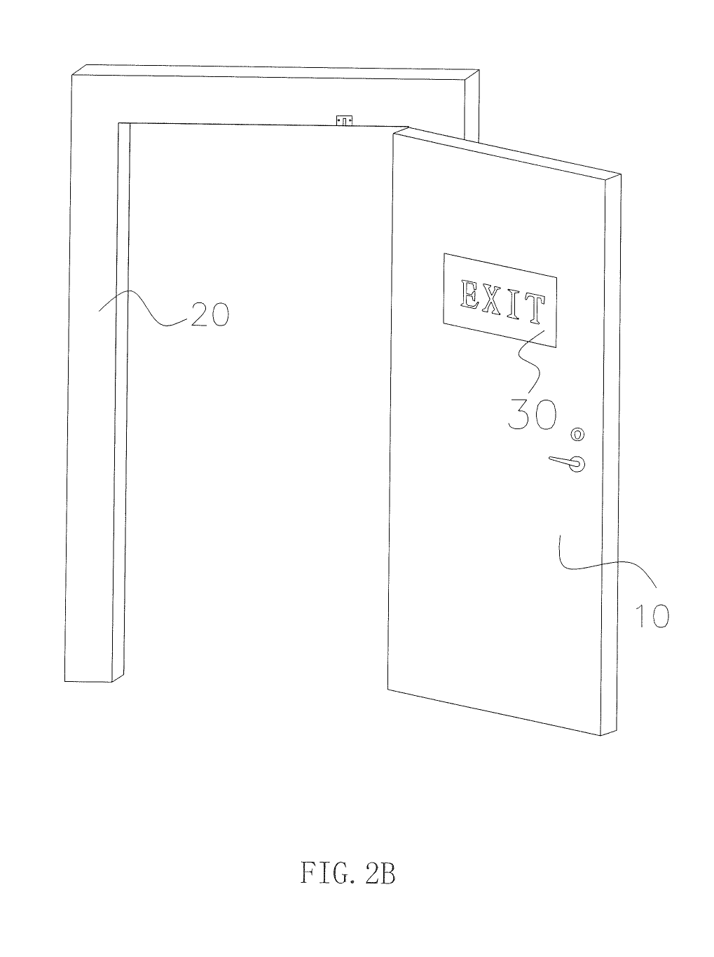

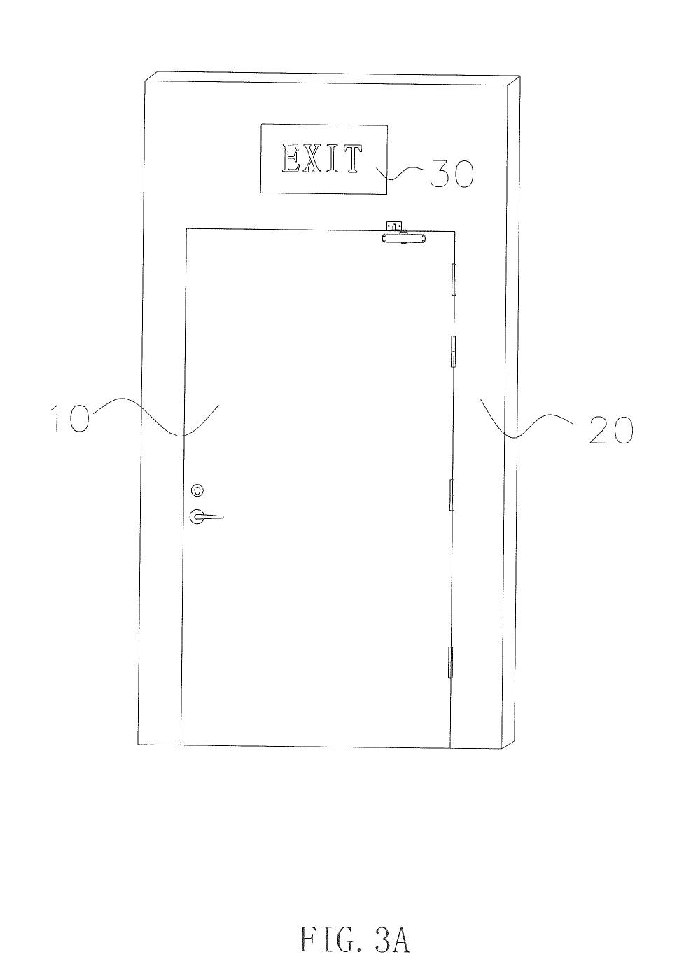

Referring to FIGS. 2A and 2B of the drawings, the self-illuminating fire door in this embodiment 2 according to the preferred embodiment of the present invention includes a structural construction identical to that of the exemplary embodiment 1 except that the front surface of the front side of the door body 10 further defines a middle portion at which the self-illuminating member 30 is positioned, as shown in FIG. 2A, and the rear surface of the rear side of the door body 10 further defines a middle portion at which the self-illuminating member 30 is positioned, as shown in FIG. 2B.

### Exemplary Embodiment 3

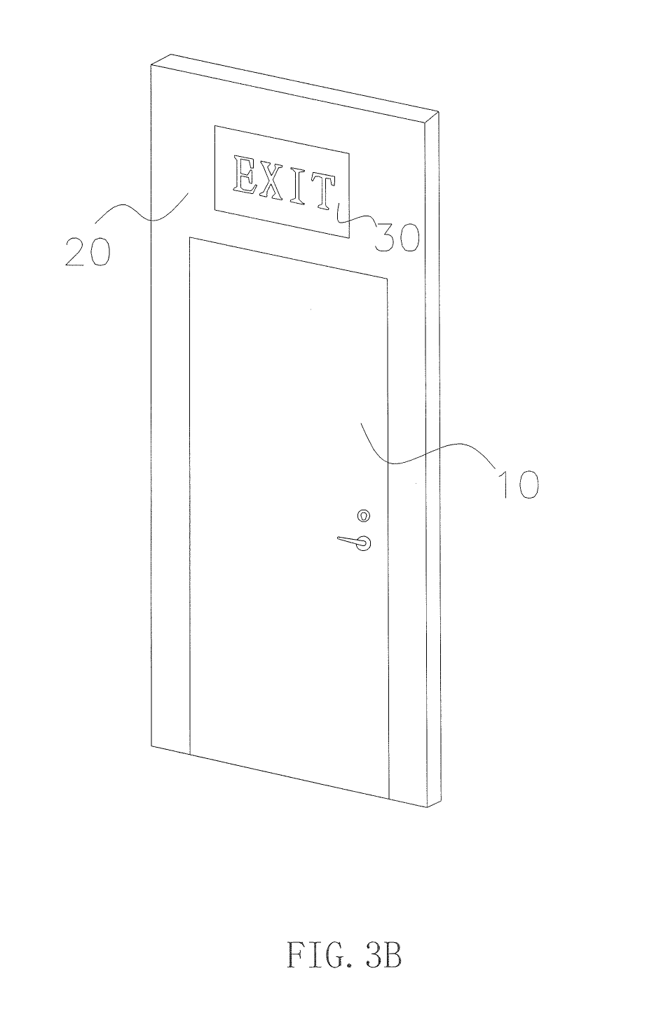

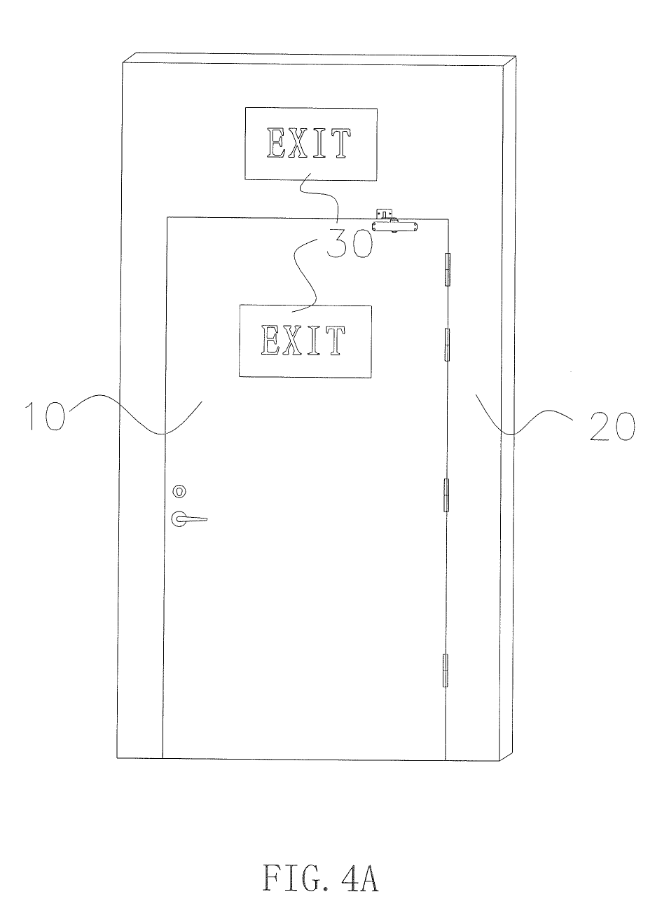

Referring to FIGS. 3A and 3B of the drawings, the self-illuminating fire door in this embodiment 3 according to the preferred embodiment of the present invention includes a structural construction identical to that of the exemplary embodiment 1 except that the self-illuminating member 30 is mounted onto a center portion of a front surface of a front side of the door frame 20, as shown in FIG. 3A; and is mounted onto a center portion of a rear surface of a rear side of the door frame 20, as shown in FIG. 3B.

### Exemplary Embodiment 4

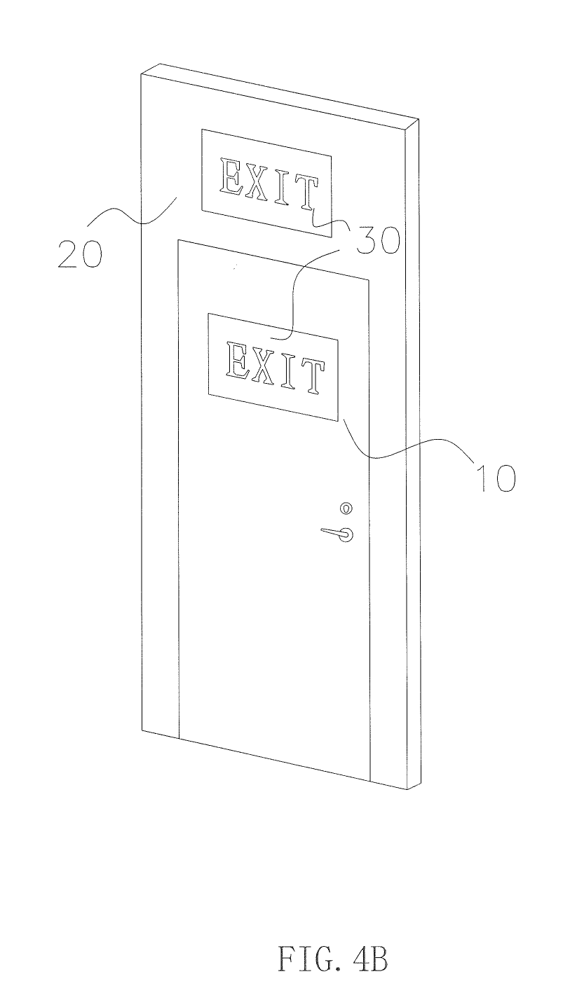

Referring to FIGS. 4A and 4B of the drawings, the self-illuminating fire door in this embodiment 4 according to the preferred embodiment of the present invention includes a structural construction identical to that of the exemplary embodiment 1 except that the self-illuminating member 30 is constructed into a flat film unit and the self-illuminating member 30 is a light-storing type self-illuminating film unit which can be designed to form a safety sign in a graphical form or in a text form, such as “ [symbol] ” in Chinese, “EXIT” in English or “ [symbol] ” in graphical form. Referring to FIG. 4A, two self-illuminating member 30 is bonded onto a front surface of a front side of the door body 10 and a front surface of a front side of the door frame 20 respectively. Referring to FIG. 4B, two self-illuminating member 30 is bonded onto a rear surface of a rear side of the door body 10 and a rear surface of a rear side of the door frame 20 respectively.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A self-illuminating fire door, comprising a door body (10) and a door frame (20) pivotally mounted together, wherein said door body (10) has two sides defining a front side and a rear side and providing a front surface and a rear surface respectively, said door frame (20) has two sides defining a front side and a rear side and providing a front surface and a rear surface respectively, wherein said fire door comprises a self-illuminating member (30) provided on one of said front and rear surfaces of said door body (10) or one of said front and rear surfaces of said door frame (20).

2. The self-illuminating fire door, as recited in claim 1, further comprising a second self-illuminating member (30) provided on one of said front and rear surfaces of said door body (10) or one of said front and rear surfaces of said door frame (20).

3. The self-illuminating fire door, as recited in claim 1, wherein said self-illuminating member is made in self-illuminating material which is capable of providing illumination in the dark and is constructed into a block unit, a rod unit or a flat film body unit.

4. The self-illuminating fire door, as recited in claim 3, wherein said self-illuminating member is in a form of the block unit or the rod unit and is mounted onto said door body (10) at said front surface of said front side of said door body (10) or said rear surface of said rear side of said door body (10).

5. The self-illuminating fire door, as recited in claim 4, further comprising a second self-illuminating member (30) in a form of the block unit or the rod unit and is mounted onto said door body (10) at said front surface of said front side of said door body (10) or said rear surface of said rear side of said door body (10).

6. The self-illuminating fire door, as recited in claim 3, wherein said self-illuminating member is in a form of the film body unit and is stick or bonded onto said door body (10) at said front surface of said front side of said door body (10) or said rear surface of said rear side of said door body (10), or onto said door frame (20) at said front surface of said front side of said door frame (20) or said rear surface of said rear side of said door frame (20).

7. The self-illuminating fire door, as recited in claim 6, further comprising a second self-illuminating member (30) in a form of the film body unit and is stick or bonded onto said door body (10) at said front surface of said front side of said door body (10) or said rear surface of said rear side of said door body (10), or onto said door frame (20) at said front surface of said front side of said door frame (20) or said rear surface of said rear side of said door frame (20).

8. The self-illuminating fire door, as recited in claim 1, wherein said self-illuminating member is made in self-illuminating material and is constructed into a text or a graphical form.

9. The self-illuminating fire door, as recited in claim 2, wherein said second self-illuminating member is made in self-illuminating material and is constructed into a text or a graphical form.

10. The self-illuminating fire door, as recited in claim 3, wherein said self-illuminating member is made in self-illuminating material and is constructed into a text or a graphical form.

11. The self-illuminating fire door, as recited in claim 4, wherein said self-illuminating member is made in self-illuminating material and is constructed into a text or a graphical form.

12. The self-illuminating fire door, as recited in claim 6, wherein said self-illuminating member is made in self-illuminating material and is constructed into a text or a graphical form.

13. The self-illuminating fire door, as recited in claim 3, wherein said self-illuminating material is an alkaline earth alluminate material, which is a light-storing type self-illuminating material.

14. The self-illuminating fire door, as recited in claim 9, wherein said self-illuminating material is an alkaline earth alluminate material, which is a light-storing type self-illuminating material.

15. The self-illuminating fire door, as recited in claim 10, wherein said self-illuminating material is an alkaline earth alluminate material, which is a light-storing type self-illuminating material.

16. The self-illuminating fire door, as recited in claim 11, wherein said self-illuminating material is an alkaline earth alluminate material, which is a light-storing type self-illuminating material.

17. The self-illuminating fire door, as recited in claim 12, wherein said self-illuminating material is an alkaline earth alluminate material, which is a light-storing type self-illuminating material.

18. The self-illuminating fire door, as recited in claim 14, wherein said self-illuminating material has a material form selected from the group consisting of powder form, film form, block form and rod form.

19. The self-illuminating fire door, as recited in claim 15, wherein said self-illuminating material has a material form selected from the group consisting of powder form, film form, block form and rod form.

20. The self-illuminating fire door, as recited in claim 17, wherein said self-illuminating material has a material form selected from the group consisting of powder form, film form, block form and rod form.
